(19) United States
(12) Patent Application Publication
(10) Pub. No.: US 2022/0021327 A1
(43) Pub. Date: Jan. 20, 2022

(54) SYSTEM THAT INCREASES SOLAR ENERGY PRODUCTION FOR LARGE SCALE SOLAR ENERGY INSTALLATIONS

(71) Applicant: STRATEGIC SOLAR ENERGY, LLC, Chandler, AZ (US)

(72) Inventor: Thomas Headley, Scottsdale, AZ (US)

(73) Assignee: STRATEGIC SOLAR ENERGY, LLC, Chandler, AZ (US)

(21) Appl. No.: 17/379,792

(22) Filed: Jul. 19, 2021

Related U.S. Application Data
(60) Provisional application No. 63/053,292, filed on Jul. 17, 2020.
(60) Provisional application No. 63/053,249, filed on Jul. 17, 2020.

(51) Int. Cl. H02S 20/10; H02S 30/10; H02S 20/20

(52) U.S. Cl. CPC H02S 20/10; H02S 20/20; H02S 30/10

(57) ABSTRACT

Systems and methods for solar energy systems are disclosed. A solar energy system comprising a plurality of elevated rectilinear solar energy structures covering an area is disclosed. Each of the solar energy structures of the plurality of elevated rectilinear solar energy structures has a long side and a short side. The plurality of elevated rectilinear solar energy structures are grouped together, oriented and aligned such that the long side of each of the solar energy structures is generally parallel and at least one of the plurality of elevated rectilinear solar energy structures has a plurality of solar panels attached in a fixed manner forming a solar energy collection canopy.

### CROSS-REFERENCE TO RELATED APPLICATIONS

This application is a non-provisional of, and claims priority to, Provisional Application Ser. No. 63/053,292 filed Jul. 17, 2020 and entitled “SYSTEM THAT INCREASES SOLAR ENERGY PRODUCTION FOR LARGE SCALE SOLAR ENERGY INSTALLATIONS”, and is a non-provisional of, and claims priority to, Provisional Application Ser. No. 63/053,249 filed Jul. 17, 2020 and entitled “SYSTEM THAT PROVIDES SHADE FOR AGRICULTURAL ENVIRONMENTS”, all of which are hereby incorporated by reference in their entirety.

### TECHNICAL FIELD

The present disclosure relates to solar energy, and in particular to solar panel support structures and solar panel arrangements on such structures.

### BACKGROUND

Large scale photovoltaic solar energy installations consume land. In previous solar installations, after solar panels have been installed on a parcel of land, the land is of little or no use for anything else. People are beginning to understand the environmental impact of such practices and land that may be dedicated to solar energy production is becoming increasingly scarce. Yet, the demand for solar energy is increasing. To solve this problem, it may be desirable to significantly increase the amount of energy that may be generated per acre of land and it may also be desirable to have a solar energy system that allows the land the solar energy system occupies to be used for other purposes in addition to generating solar energy.

### SUMMARY

A solar energy system comprising a plurality of elevated rectilinear solar energy structures covering an area, wherein each of the solar energy structures of the plurality of elevated rectilinear solar energy structures has a long side and a short side. The plurality of elevated rectilinear solar energy structures may be grouped together, oriented and aligned such that the long side of each of the solar energy structures are generally parallel and at least one of the plurality of elevated rectilinear solar energy structures has a plurality of solar panels attached in a fixed manner forming a solar energy collection canopy.

A method of collecting solar energy by installing a first solar energy structure covering an area, the first solar energy structure being long, narrow and elevated. Installing one or more additional solar energy structures, the one or more additional solar energy structures being long, narrow and elevated. The one or more additional solar energy structures being parallel to the first solar energy structure. The first solar energy structure and the one or more additional solar energy structures forming a solar energy system. At least one portion of at least one of the long, narrow and elevated solar energy structures support a canopy of solar energy collectors. At least one of the solar energy collectors supported by the canopy of solar energy collectors are tilted between 0° and 15° relative to the canopy of solar energy collectors or relative to horizontal. The canopy of solar energy collectors is elevated to a minimum of 4 feet above the area covered.

A method of collecting solar energy includes installing a first solar energy structure covering an area. The first solar energy structure being long, narrow and elevated. The method includes installing one or more additional solar energy structures. The one or more additional solar energy structures being long, narrow and elevated, and parallel to the first solar energy structure. The first solar energy structure and the one or more additional solar energy structures forming a solar energy system. At least one portion of some of the long, narrow and elevated solar energy structures support a canopy of solar energy collectors. At least one of the solar energy collectors supported by the canopy of solar energy collectors are tilted between 0° and 15° relative to the canopy of solar energy collectors. The canopy of solar energy collectors is elevated to a minimum of 4 feet above the area covered. The method includes determining a desired amount of sunlight to reach the area covered by the solar energy system in order for the area to be used for purposes in addition to collecting solar energy. The method also includes, at a given height of the solar structures, adjusting a ratio of a width of the canopy of solar energy collectors to a separation distance from one long side of at least one of the first solar energy structure and the one or more additional solar energy structures to the long side of an adjacent solar energy structure to achieve the desired amount of sunlight reaching the area covered by the solar energy system.

In an example embodiment, the method may comprise dividing the long, narrow and elevated solar energy structures into sections, each section being self-supporting and taking advantage of less expensive designs including panels overhanging the ends of the structure. These solar tables can together, but without touching, comprise the long, narrow solar structure described above. In a further example embodiment, the method may comprise solar tables, each comprising elevated solar energy structures that are each self-supporting with panels overhanging two or more sides of the structure, wherein the solar tables together, without touching, comprise a long, narrow solar structure.

In an example embodiment, the method may comprise adding an addon structure to the solar table described above. The addon unit may be designed to connect to the main structure by the purlins of the structures with plates and may add additional energy capacity and shade to a structure.

In an example embodiment, the method may comprise placing the solar tables independently or in any combination or orientation. This independence of the solar table is particularly useful for applications such as oil pumps, parks, greenhouses, back yards of homes and the like that require less energy.

In an example embodiment, the method may comprise using the shade generated by the long, narrow structures to cover electrical assets and other assets from the sun so that they operate cooler and more efficiently. Assets that could be covered include, inverters, batteries, transformers, meters and diesel or natural gas generators and other similar items.

In an example embodiment, a microgrid energy system may comprise: at least one of an energy storage system, a generator, a control system and a solar energy collection system, wherein the solar energy collection system of the microgrid energy system comprises a group of elevated structures covering an area, each structure supporting one or more solar energy panels forming a canopy on the group of elevated structures, the longer side of at least one of a canopy of solar energy collectors being oriented parallel to the longer side of the canopy of solar energy collectors supported by neighboring solar energy structures.

In an example embodiment, a solar energy system comprises: a plurality of elevated rectilinear solar energy structures covering an area, wherein at least two of the solar energy structures of the plurality of elevated rectilinear solar energy structures each comprise a solar table, wherein each solar table comprises a first pair of columns supporting a first crossbeam, a second pair of columns supporting a second crossbeam, and a third pair of columns supporting a third crossbeam, wherein each column is secured to the ground with a screw type securement, and each solar table further comprising pairs of purlins supported by the first, second, and third crossbeams, and each solar table further comprising solar panels, with each solar panel supported by at least one pair of purlins in a fixed manner forming a solar energy collection canopy, wherein each solar table comprises a long side and a short side, the plurality of elevated rectilinear solar energy structures grouped together, oriented and aligned such that the long side of each of the solar energy structures are generally parallel.

### BRIEF DESCRIPTION OF THE DRAWINGS

With reference to the following description and accompanying drawings:

FIG. 1 illustrates a perspective view of an example embodiment of the systems and methods described herein;

FIG. 2 illustrates examples of separation for solar panels with 25° of tilt, 5° of tilt and 0° of tilt;

FIG. 3 illustrates an example embodiment of the systems and methods described herein;

FIG. 4 illustrates a top view of an example embodiment of the systems and methods described herein;

FIG. 5 illustrates an example embodiment with the structures spread apart;

FIG. 6 illustrates an additional example embodiment with the structures spread apart;

FIGS. 7A-7D illustrate examples of solar panel mounting options;

FIG. 8 illustrates examples of configurations of the structures included in the systems and methods described herein;

FIG. 9 illustrates an example microgrid configuration;

FIG. 10 illustrates examples of options for additional uses of the systems and methods described herein;

FIG. 11 illustrates examples of options for additional uses of the structures described herein;

FIGS. 12A-12E illustrate additional example structures, in accordance with various example embodiments; and

FIGS. 13A-13C illustrate additional example structures, in accordance with various example embodiments.

### DETAILED DESCRIPTION

In a large-scale solar energy collection system using current technology, the solar panels are mounted on racks. The lowest solar panels on such racks may be mounted near the ground, e.g., approximately one foot above the ground. The highest solar panels may be mounted on the tops of the racks, e.g., the solar panels may be 8 or more feet above the ground. All of the solar panels may be tilted in one direction (e.g., often to the south in the Northern Hemisphere or to the north in the Southern Hemisphere) and at an angle determined to, on average, collect the most energy possible per panel over a year. The tilt angle may vary by the latitude of the location. As an example, at a latitude of 33° (e.g., near Phoenix, Ariz., USA), the most desirable tilt angle may be directly south at 25° from horizontal. Between the rows of solar panels may be rows of land without solar panels. The purpose of this open land is to keep the solar panels in one row from being shaded by the shadow cast by the neighboring row to, in this example, the south at certain times of the day and year. The rows of open land may also serve as drive aisles and service pathways to maintain the solar energy system. However, at most times of the day during most days of the year, sunshine may be hitting some or all of the open land and may therefore not be available to be converted into solar energy. A solar energy system such as the one described above using 400-watt solar panels might have about 21.7 megawatts d.c. of solar panels installed on 50 acres of usable land and may produce 37,989 megawatt-hours of energy in a year.

A traditional solar energy system as described above has been set up to maximize the energy potential for every individual solar panel. However, the solar energy system disclosed herein instead maximizes the solar energy produced across the entire system.

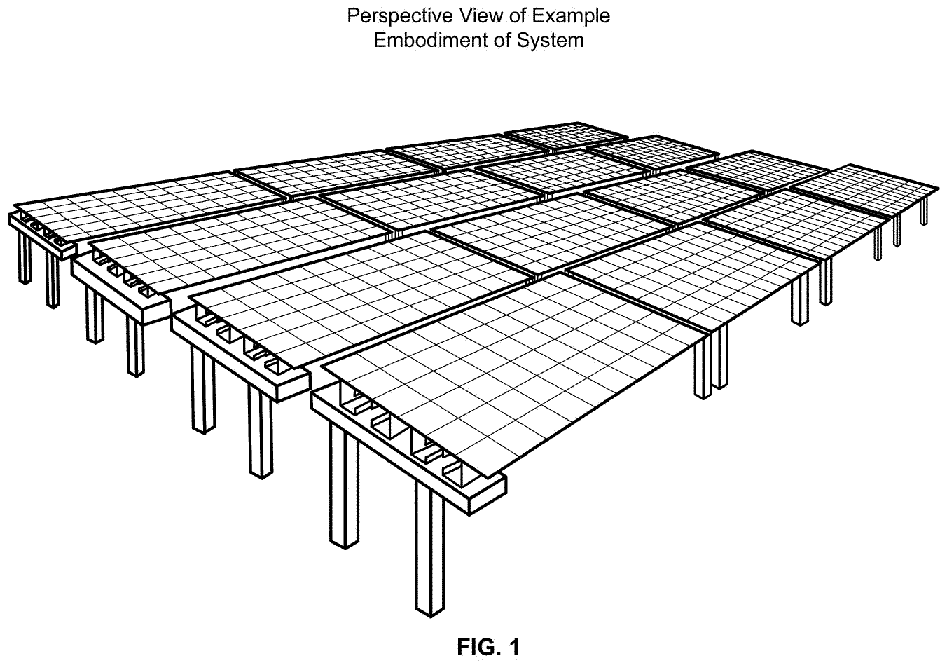

FIG. 1 illustrates a perspective view of an example embodiment of the systems and methods described herein. In the example embodiment of FIG. 1, a structure may be created that raises all the solar panels above the ground. The solar panels may be mounted in a fixed manner and at a low angle to horizontal, e.g., at or near 0° to 15°, or more. The solar panels may be mounted in such a manner that any solar panels requiring service or replacement may be removed and serviced from underneath the structure. Elevating the entire photovoltaic solar energy collection system may allow installation and service personnel to walk under and drive vehicles under the entire system in order to install and service the solar panels and may thereby eliminate the need for open land to be used as drive aisles and service pathways and may increase the amount of solar energy that may be produced on a given area of land. Alternatively, elevating the entire photovoltaic solar energy collection system may open up the land used for the solar energy system to be additionally used for other purposes.

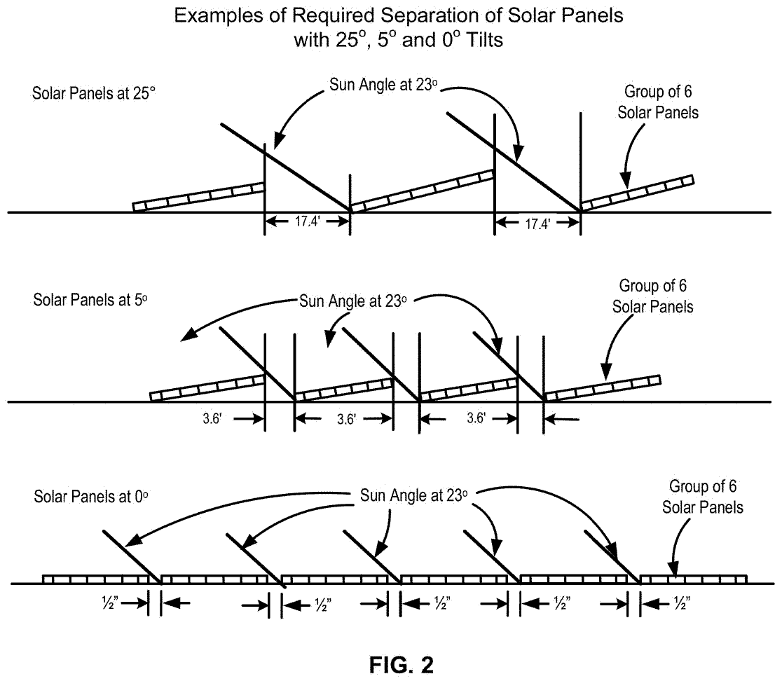

FIG. 2 illustrates examples of separation for solar panels with 25° of tilt, 5° of tilt and 0° of tilt. Mounting the solar panels at a relatively low angle relative to the horizon reduces the need to leave land open to prevent one row of solar panels from shading that row of solar panel's neighboring row of solar panels. As illustrated in FIG. 2, given a desired condition where sun angles above the horizon of 23° and larger do not allow one group of solar panels to shade another, mounting solar panels at 25° means that the shade cast by six solar panels mounted in landscape mode requires a spacing between rows of about 17.4 feet. Mounting six solar panels mounted in landscape mode at 5° requires a spacing between rows of 3.6 feet. Further, mounting the solar panels flat to the horizon (0°) means that the solar panels require a spacing between rows of only the space generally required between any adjacent solar panels or about 0.5 inches. Therefore, in accordance with an example embodiment, an installation comprising two or more rows (lines) of solar panel structures may be configured such that, for equal areas defined around the installation and assuming similar sized solar panels, an installation with solar panels mounted at a greater angle may have fewer solar panels than an installation with solar panels mounted at a lesser angle (e.g. mounted at 25° to the horizon is greater than mounted at 5° to the horizon, and mounted at 0° to the horizon is lesser than mounted at 5° to the horizon). Solar panels lose about 10% of their efficiency by being mounted at 0° versus being mounted at 25°, depending on the latitude of the location and the type of the solar panel. The increased density of the solar panels on the land more than makes up for the loss of efficiency per solar panel, however.

As discussed with respect to FIGS. 1 and 2, above, in various example embodiments, the solar panels are directed towards the sun or may lay flat. In an example embodiment, the angled solar panels are set at an angle selected to maximize the energy produced per individual solar panel over a particular period of time. In contrast, in an example embodiment, the flat solar panel orientation is selected to create more shade, and also to create more energy per unit area of land on which the solar panels may be placed than that of a system with solar panels angled to generate maximum energy for the particular latitude of the location.

Stated another way, in an example embodiment, a first solar structure system comprises a solar-shade structure system with panels in a fixed orientation that are flat, or that are angled relative to horizontal significantly less than the angle of a second solar structure system. In that example embodiment, if both the first solar structure system and the second solar structure system were built to reside within those outer boundaries whose areas was the same area, then (1) the average energy generation (energy density) for the area is greater for the first solar structure system than the second solar structure system, and (2) the panel density for the area is greater for the first solar structure system than for the second solar structure system. Therefore, in an example embodiment, individual solar panels at low orientations collectively generate more energy than if they were oriented at their optimal operation orientation.

Flat solar panels may produce more power per unit area of land because the flat solar panels do not shade solar panels near them. The solar panels may be essentially butted up against each other to maximize the number of solar panels in a given area, and thereby maximize the energy produced in that area. Alternatively, the solar panels may still be spaced apart to provide sunlight to areas generally below and in the vicinity of the solar panels, while still maximizing the energy produced (or at least producing relatively more energy than a similarly situated system with panels individually angled for optimal energy generation) for a given area. In other words, the solar energy produced may be maximized within the constraints of solar energy needed to grow crops, the solar energy for livestock, or the solar energy for any other use in addition to the use of solar energy for the solar panels. Angled solar panels may shade other solar panels if the rows of solar panels are too close together. Accordingly, flat solar panels may produce less energy per panel, but may produce more energy per unit area.

Angled solar panels may produce more energy per individual solar panel because solar panels are more efficient per unit area of the solar panel when pointed directly at the sun as compared to the flat solar panel. However, using angled solar panels may reduce the number of solar panels in a given area because rows of solar panels may have to be separated to avoid one row of solar panels from shading another row of solar panels. Accordingly, angling the solar panels may reduce overall energy output of a system as compared to flat panels and may reduce the effective shade as well.

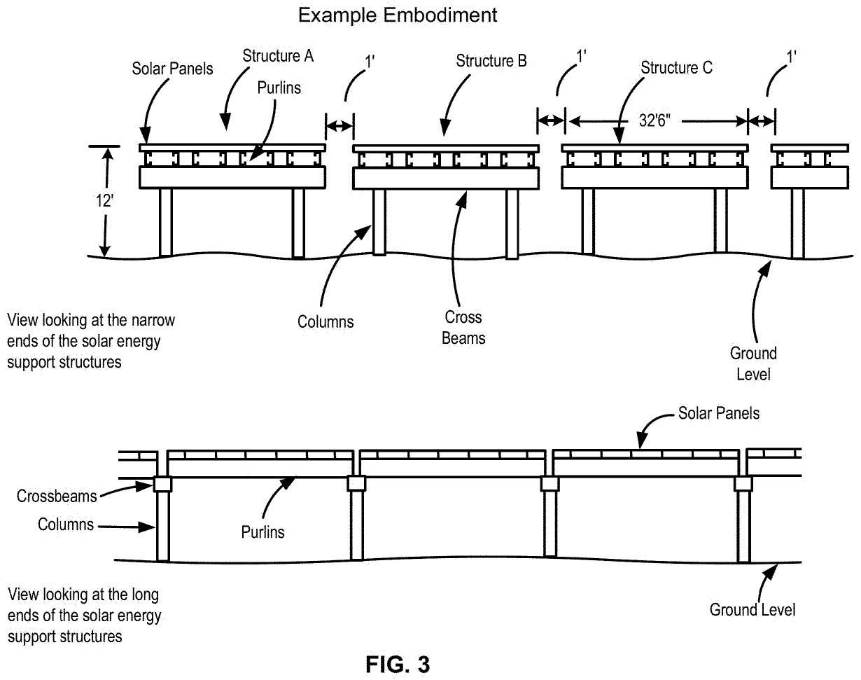

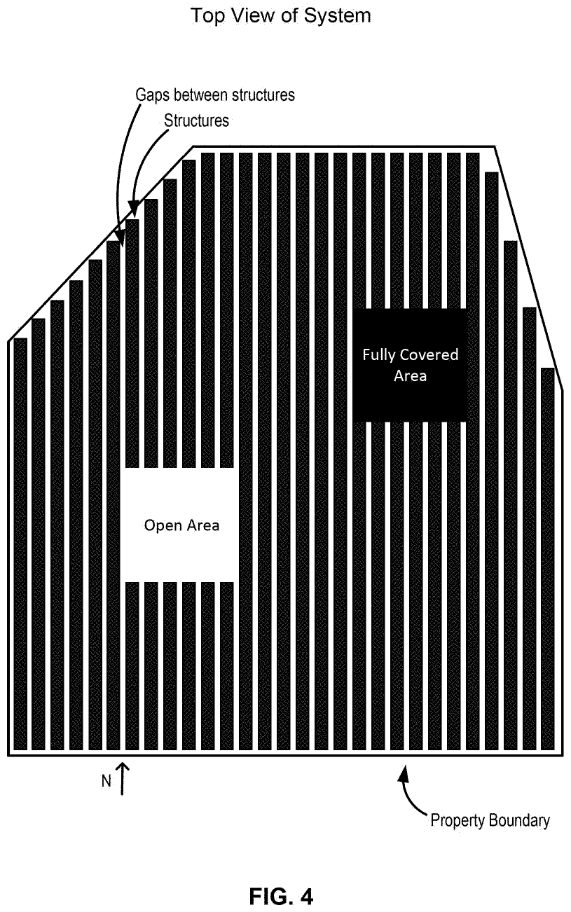

FIG. 3 illustrates an example embodiment of the systems and methods described herein. The example embodiment of the solar panel mounting system of FIG. 4 may be designed to maximize the solar energy produced from the available area the solar panel mounting system and the attached solar panels cover. The solar panel mounting system may be comprised of multiple long and narrow structures supporting elevated solar panel canopies constructed next to each other and parallel to each other. The side and end views of one of the structures with solar canopies that may comprise this embodiment of the solar energy system are illustrated in FIG. 4. In this example, the width of the solar canopy may be 32 feet 6 inches and the separation between adjacent solar canopies may be 1 foot. Further, for this example, the height of the solar panel canopy may be 12 feet. The length of the solar canopies may be whatever the land allows. This solar panel mounting system using 400-Watt solar panels might allow 33.5 megawatts d.c. of solar panels to be installed on 50 acres of usable land and may produce 54,000 megawatt-hours of energy in a year, for example. While the example of FIG. 3 is described using specific measurements, e.g., the solar canopy may be 32 feet 6 inches wide, 12 feet high and with a separation between adjacent solar canopies of, for example, 1 foot, it will be understood that other solar canopy widths, separations, and heights are also possible, as will be understood by a person of ordinary skill in the art after reviewing the disclosure. In an example embodiment, a ‘long’ structure may be 2, 3, 4, 5, 10 times as long as the width of the structure, though other ratios may be suitable as well.

FIG. 4 illustrates a top view of an exemplary system application. In the illustrated example of FIG. 4, the structures run north and south. As illustrated in FIG. 4, gaps may exist between structures and how fully covered areas might exist. The top view of FIG. 4 illustrates how the system may be adapted to different areas, fence lines, property boundaries, etc. For example, the top view illustrates an open area generally south and east of the center of the illustrated property and a filled area generally north and west of the center of the illustrated property.

Alternately, the structures may be directed east and west or at any desirable angle. In an example embodiment, the solar panels are flat, and orientation of the structures makes no difference. However, to make use of the attributes of leaving the land open for other uses, a north and south orientation may be preferred.

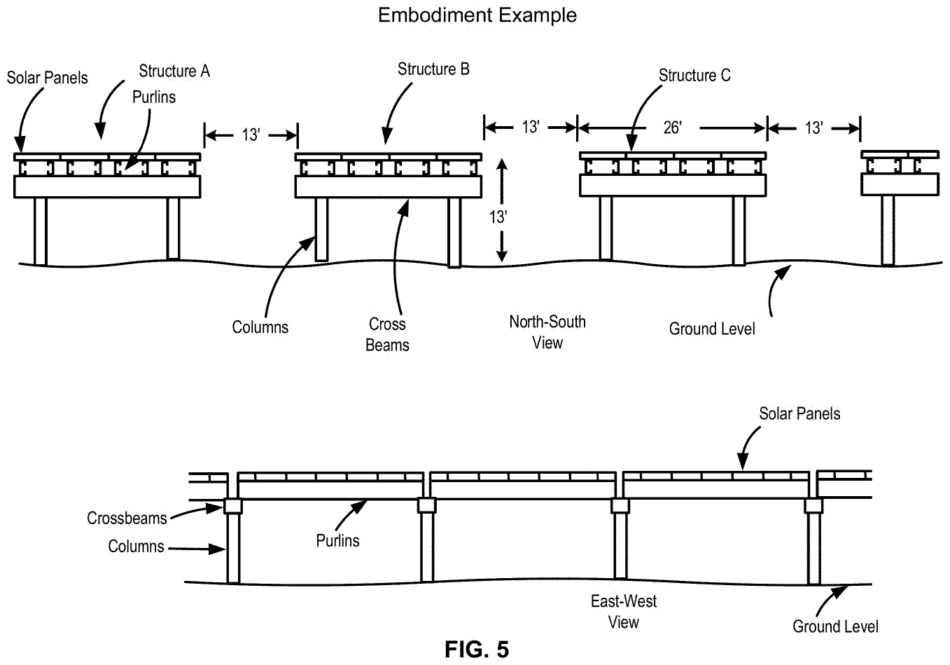

FIG. 5 illustrates an example embodiment with the structures spread apart. The embodiment of FIG. 5 may be designed to enable the land on which the solar energy system is located to additionally be used for other purposes. The solar energy system may comprise multiple long and narrow structures supporting elevated solar panel canopies constructed next to each other, parallel to each other and separated from each other by a specifically determined distance. In this embodiment, the elevated solar panel canopies may be positioned with the long direction pointed generally north and south. The side and end views of the structures that may comprise this embodiment of the solar energy system are illustrated in FIG. 5. In this example, the width of the solar canopy may be 26 feet and the separation between adjacent solar canopies may be 13 feet. Further, for this example, the height of the solar panel canopy may be 13 feet. The length may be whatever the land allows. This embodiment of the system, using 400-Watt solar panels, might allow 23.2 megawatts d.c. of solar panels to be installed on 50 acres of usable land and may produce 37,380 megawatt-hours of energy in a year, which may be an equivalent amount of solar energy as a traditional large-scale ground mount but may leave the land the example solar energy system covers available for other uses. This particular combination of dimensions provides shade and sunshine to hit the land in the ratio of two portions of shade to one portion of sunshine. The split of solar energy being used to produce electricity and the sunshine allowed to reach the ground under the example solar energy system may be useful for growing plants that grow better at that location in some shade rather that in direct sunlight or for providing shade for animals grazing on the land.

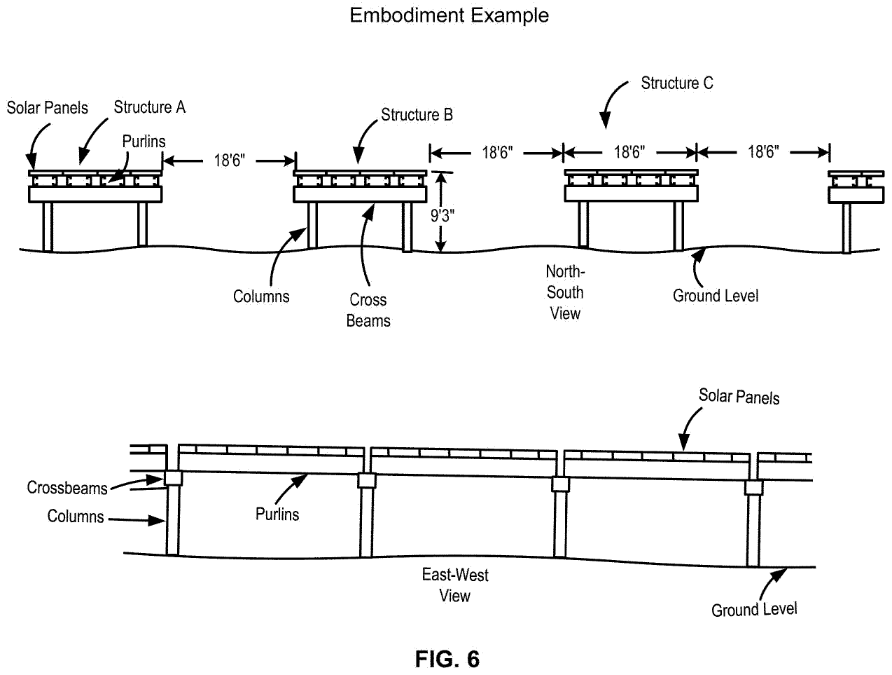

FIG. 6 illustrates an additional example embodiment with the structures spread apart. In the embodiment of FIG. 6, the elevated solar canopies may be configured to provide shade and sunshine to the area the system covers in the ratio of one shade to one sunshine. As in the previous embodiment, the multiple long and narrow solar canopies may be pointed generally north and south and may be constructed next to each other, parallel to each other and separated from each other by a specifically determined distance. As illustrated in FIG. 6, in this embodiment, the width of the solar canopy may be 18 feet 6 inches and the separation between adjacent solar canopies may also be 18 feet 6 inches. For this example, the height of the solar panel canopy may be 9 feet 3 inches. The length of the solar canopy may be whatever the land allows. This embodiment of the system, using 400-Watt solar panels, might allow 17,544 megawatts d.c. of solar panels to be installed on 50 acres of usable land and may produce 28,250 megawatt-hours of energy in a year, which is less energy per year than the previous example because the shade to sunshine ratio allows more sunshine to hit the ground under the system. The energy produced may still be a meaningful and useful amount of electrical energy production.

In another embodiment, the long and narrow solar structures may be built with any compass orientation. For instance, the long and narrow sides of the solar support structures may be oriented generally east and west or oriented in any other chosen direction.

Further, the solar collection structures do not need to be parallel to each other or grouped together and instead may be built as individual structures such as solar tables. As an example, individual structures or several individual structures or solar tables might be placed over a public park in a scattered manner to provide shade to various portions of the park as chosen by the landscape designer while still providing significant amounts of solar energy. Alternately, an individual solar table or a group of solar tables might be used to support a remote asset such as a oil pump, a cell phone transmission tower, a greenhouse or an individual home.

Other embodiments and combinations are also envisioned. Various combinations of the system's parameters may be incorporated in an exemplary solar energy collection system that may provide the desired combination of energy produced and land use for a specific location. Additionally, more than one combination of system parameters may be used to create a system at a particular location.

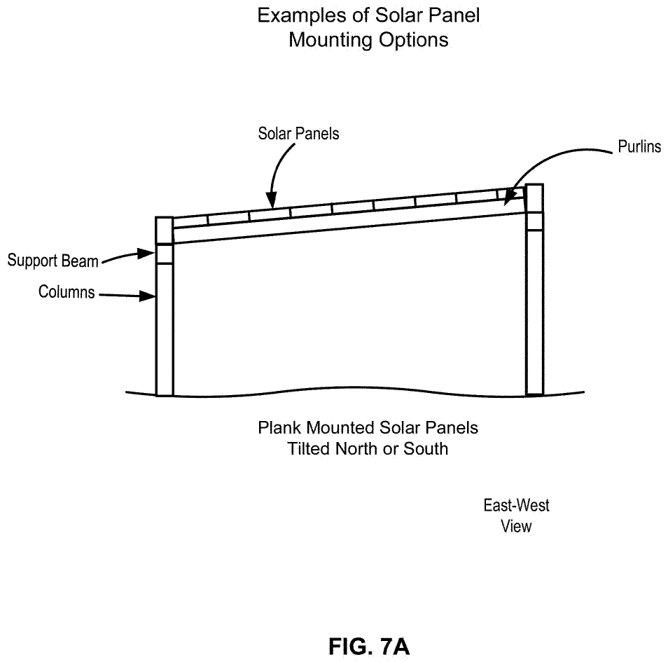

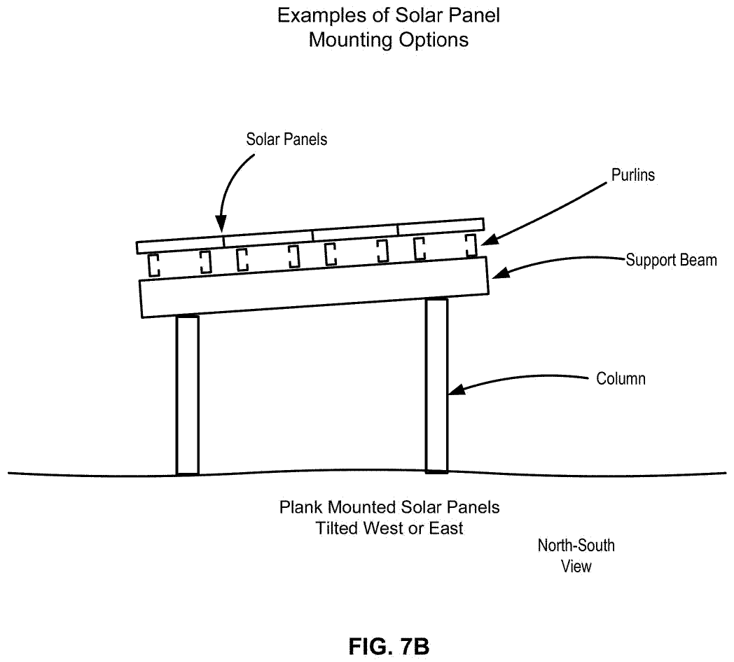

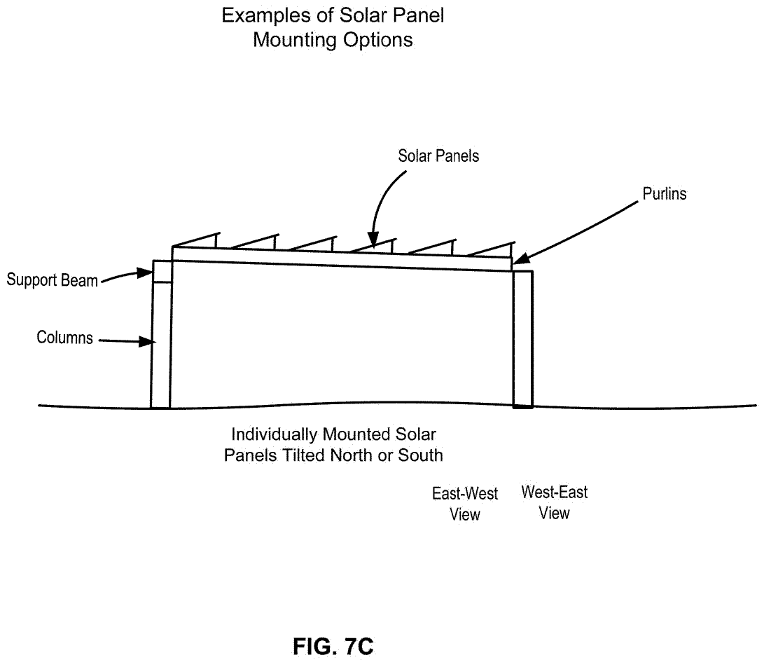

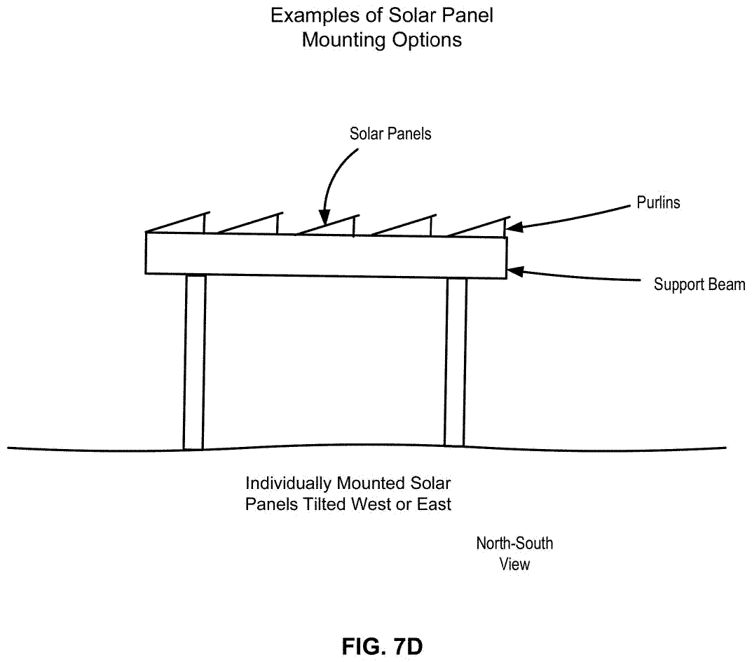

FIGS. 7A-7D illustrate examples of solar panel mounting options. The solar panel mounting options may include one or more of purlins, support beams, or columns. In some embodiments, solar panels may be ganged together to form planks of solar panels (e.g., FIGS. 7A-7B). In other embodiments, solar panels may be mounted individually (e.g., FIGS. 7C-7D). In some embodiments, the solar panels may be tilted at any workable angle (e.g., FIGS. 7C-7D), and particularly in the range of 0° to 15° from horizontal. Further, the solar panels may be tilted to the north, south, east or west or any direction in between as illustrated in FIGS. 7A-7D. In the Northern Hemisphere, tilting the panels to the south may maximize the total daily output of the system. Tilting the solar panels to the north may reduce the energy output. The opposite may be true in the Southern Hemisphere. In both hemispheres, tilting the solar panels to the east may increase morning energy output but reduce afternoon energy output. Tilting the solar panels to the west may reduce morning energy output but increase afternoon energy output. Further, solar panels may be purposely left out of the solar canopy or spaced closer together or further apart, be monofacial or bifacial and be of different degrees of transparent to opaque to allow different amounts of energy to be collected and different patterns of sunshine to reach the area covered, if so desired. Other arrangements of the solar panels in the canopies of the system and other solar energy collection materials, such as shingles, cloth and paint among others, mounted on any appropriate surface are also intended to be included in an embodiment.

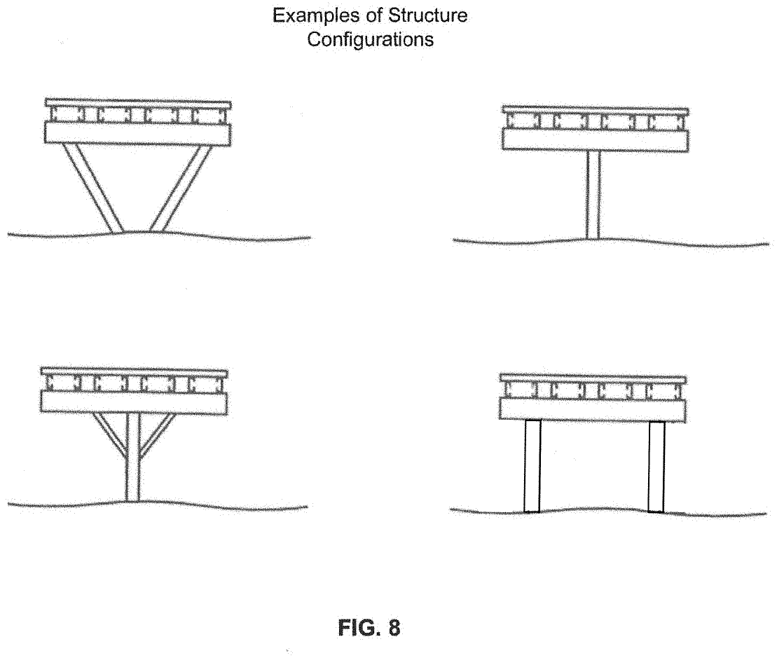

FIG. 8 illustrates examples of configurations of the structures included in the systems and methods described herein. There may be multiple ways to design and construct the support structure of the solar canopies or solar tables of the system. Several examples are illustrated in FIG. 8 in addition to the one illustrated in FIG. 3, but many others may be feasible and are included in the scope of the systems and methods described herein. Further, the structures may be constructed of various metals, concrete, wood or any other structural material or combinations of structural materials. Which type of structure is best suited for a particular system in a particular location may be decided after considering factors, such as cost, local design parameters, soil type, required height, the extent of the overhang, as well as other factors that may impact the design of the structure. Other configurations than the examples shown in FIG. 8 are envisioned and will be clear to those of skill in the art after reviewing this disclosure.

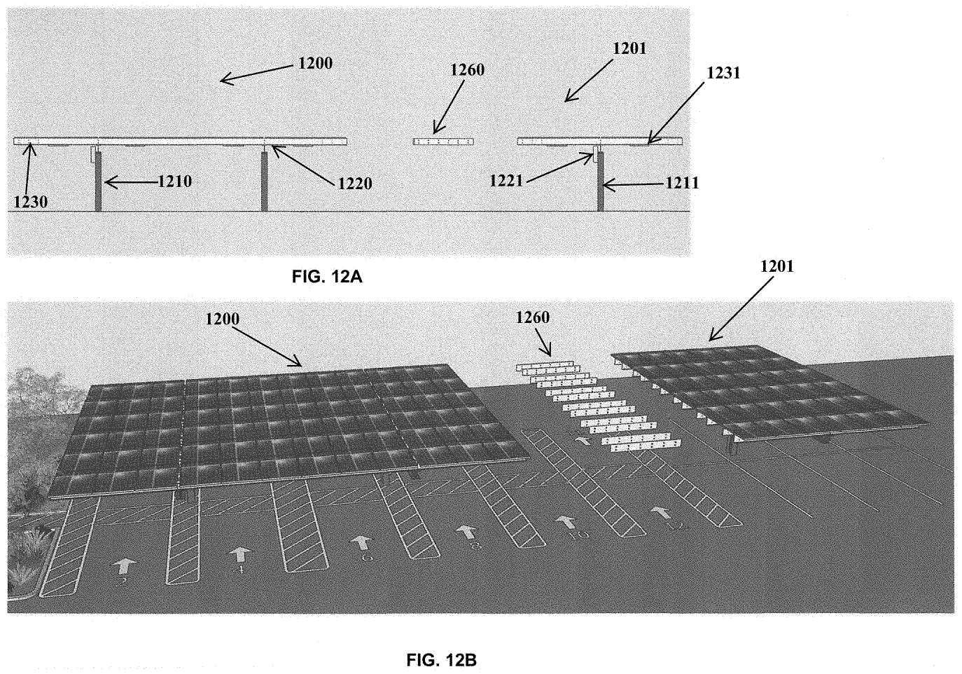

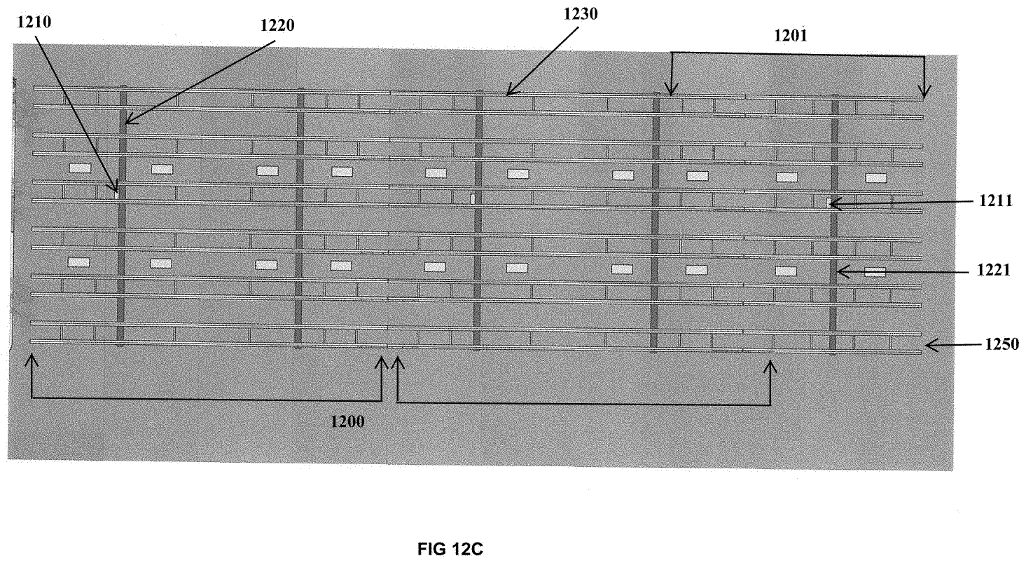

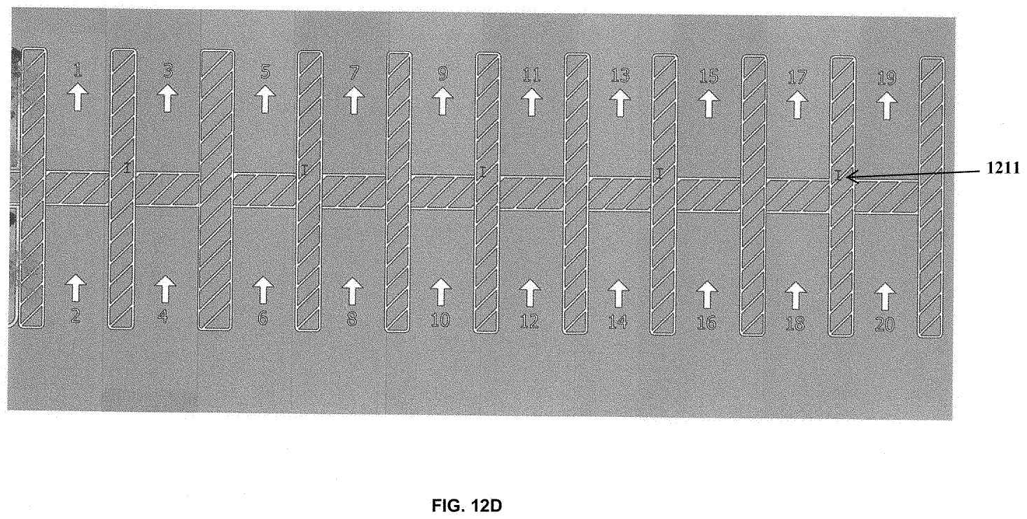

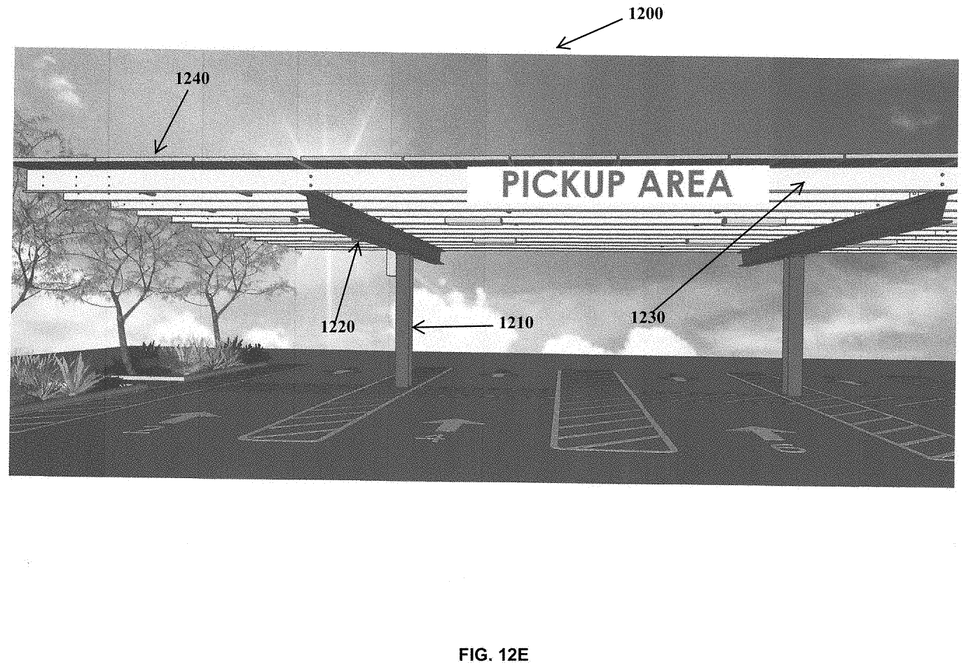

With momentary reference now to FIGS. 12A-12E, in accordance with an example embodiment, a solar table 1200 may comprise two columns (e.g. 1210). Each column 1210 may support a crossbeam 1220 to form a T shaped structure. In an example embodiment, the crossbeam is 40 feet long, though other lengths may be used. In one example embodiment, the columns 1210 may be 25 feet apart. However, the columns 1210 may be spaced apart at any suitable spacing for the use provided beneath the structure. For example, the two columns may be optimally set for a structure in a parking lot that covers a pickup area or a electric car charging area to handle customers. In this embodiment, two drive aisles and room for an employee to walk may be fit between the two columns for pickup drive aisles.

The crossbeams may support purlins 1230, and solar panels 1240 may be supported off of these purlins 1230. In an example embodiment pairs of purlins may extend across both crossbeams. In an example embodiment, each solar panel may be supported by a pair of purlins 1230. In one example embodiment, the pulins 1230 span the distance between the two crossbeams. In another example embodiment, the purlins 1230 further extend cantilevered past the two cross beams. In an example embodiment, the pulins 1230 are parallel to each other and perpendicular to the crossbeams, though other angles may be used. In an example embodiment, there are 6 sets of pairs of purlins (see 1250), though other numbers of purlins pairs may be used. Each set of purlins (e.g. 1250) may be approximately 50 feet long, though other lengths may be used, and may support the solar panels 1240 and overhang the cross beams. In an example embodiment, the two columns (1210 typ.) elevate the solar panels to a sufficient height above the ground to allow easy access to and passage of cars/trucks underneath the structure. Thus, in an example embodiment, the solar table has a long dimension in the long direction direction of the purlins 1230 and a narrow dimension in the direction of the length of the crossbeam 1220.

In a further example embodiment, a structure 1201 (e.g., a half-structure) may comprise a single column 1211 with a single crossbeam 1221 forming a T like structure. Purlins 1231 may be supported from the crossbeam 1221. In an example embodiment, the purlins 1231 are supported at right angles to the crossbeam 1221, though other angles may be used. In an example embodiment, solar panels 1241 are supported by the purlins 1231. For example each solar panel may be supported by a pair of purlins. In an example embodiment, the half-structure 1201 may be connected to a full-structure 1200. For example, the connection can be made by plates 1260 connecting purlins 1230 of the full-structure to purlins 1231 of the half-structure. However, any method of connecting one or more purlins may be used. The connection is configured to add structural support to the half-structure, making it as strong as the full structure when tied together.

More broadly, in one example embodiment, the structure 1200 may be designed to be connected to another structure by means of plates 1260 which connect the structures (e.g. structures 1200 and 1201) purlin to purlin. In a first example embodiment, a structure 1200 can connect to another full section of solar panels with two columns and two crossbeams (as described above, not shown). In a second example embodiment, a first structure 1200 as described above may be connected to a second structure 1201 comprising one column and one crossbeam with about half of the solar panels (as described below). In an example embodiment, the structures may be connected end-to-end along the direction of the purlins (i.e., in the long direction).

The solar tables described in the preceeding paragraphs may have multiple applications. In an example embodiment, the solar tables may have different lengths to cover more or to cover fewer cars/trucks. In an example embodiment, the solar tables may be useful in connection with a pickup area for stores delivering purchased goods to cars and for electric vehicle charging areas.

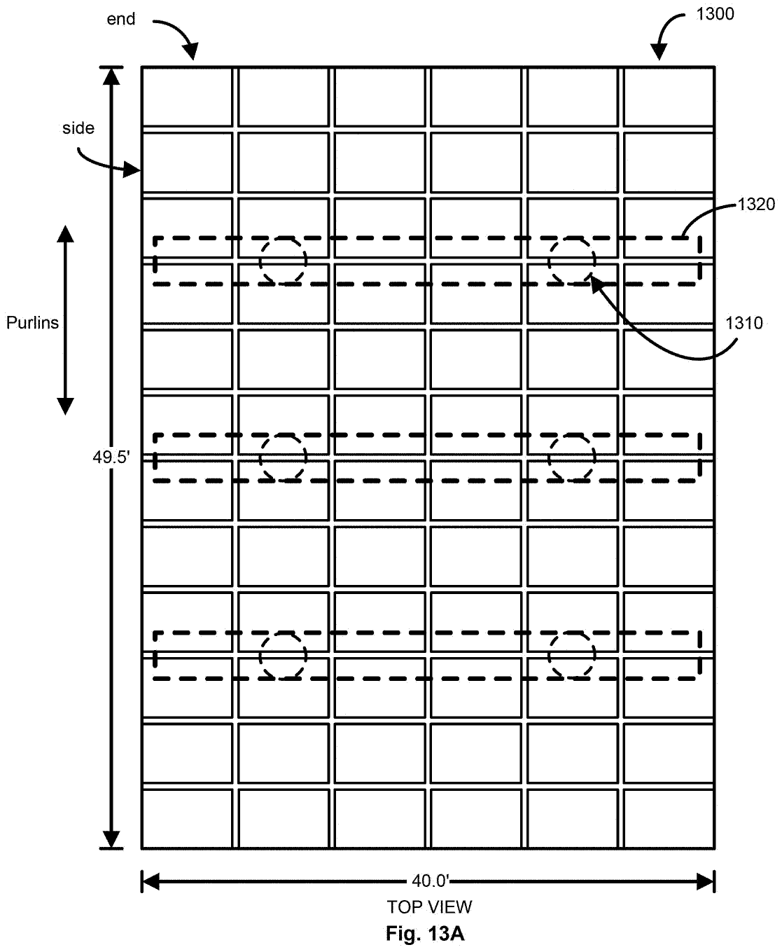

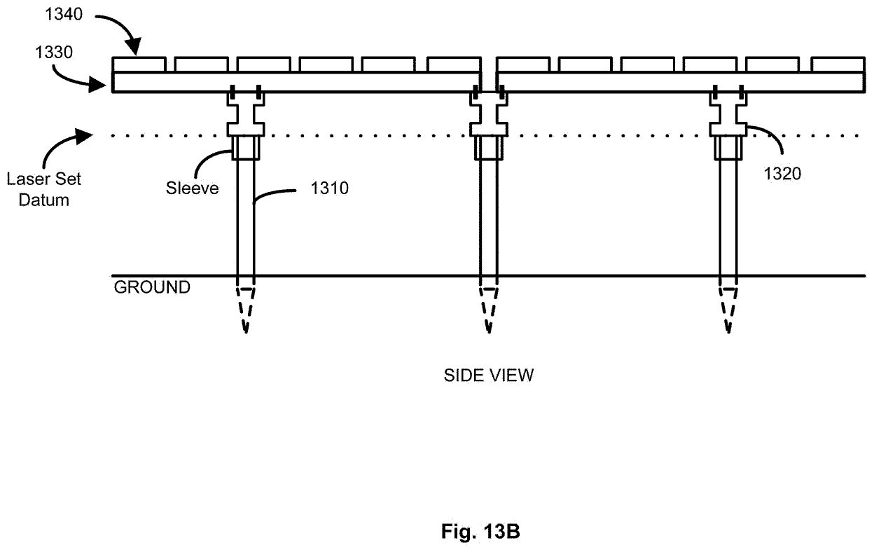

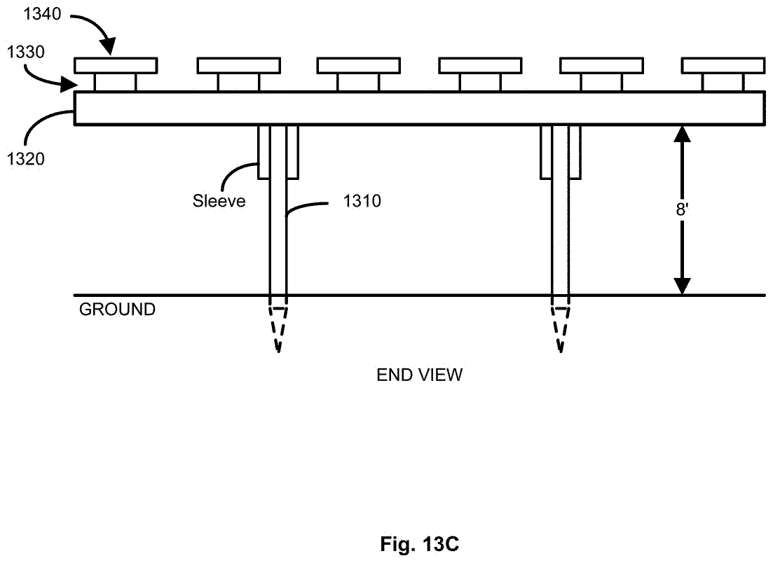

With reference now to FIGS. 13A, 13B, and 13C, in accordance with another example embodiment, a solar table 1300 may comprise three sets of two column pairs. Each column 1310, in an example embodiment is a drilled column (i.e., screw type securement), though the columns could be secured in the ground using concrete or other methods of attachment. A crossbeam 1320 may extend between a pair of columns 1310. As illustrated in FIG. 13A, three crossbeams (1320 typ.) are supported by two columns (1310 typ.) each. In this example embodiment the columns 1310 may be separated by about 25 feet between each pair, and the pairs of columns may be separated by about 20 feet, however other separation distances may be used. With reference to FIG. 13B, the structure 1300 may be configured to support purlins 1330 which in turn support the solar panels 1340. Each purlin 1330 may be supported by at least two of the crossbeams. Moreover, in an example embodiment, each solar panel 1340 may be supported by at least two purlins 1330. In an example embodiment, the structure is designed to hold the solar panels from about 4 feet to about 20 feet above the ground over hills and washes and other ground irregularities. In this example embodiment, the solar table 1300 comprises a panel matrix that is six panels by twelve panels, though any suitable number of panels may be used.

Solar tables similar to the ones described above placed end-to-end may make up the long, narrow solar structure described above. The long, narrow solar structures may be placed side-to-side in rows spaced apart to complete the solar structure and provide large amounts of energy. However, the solar tables can also be used as a standalone structure or in small groups for installations that require less solar energy.

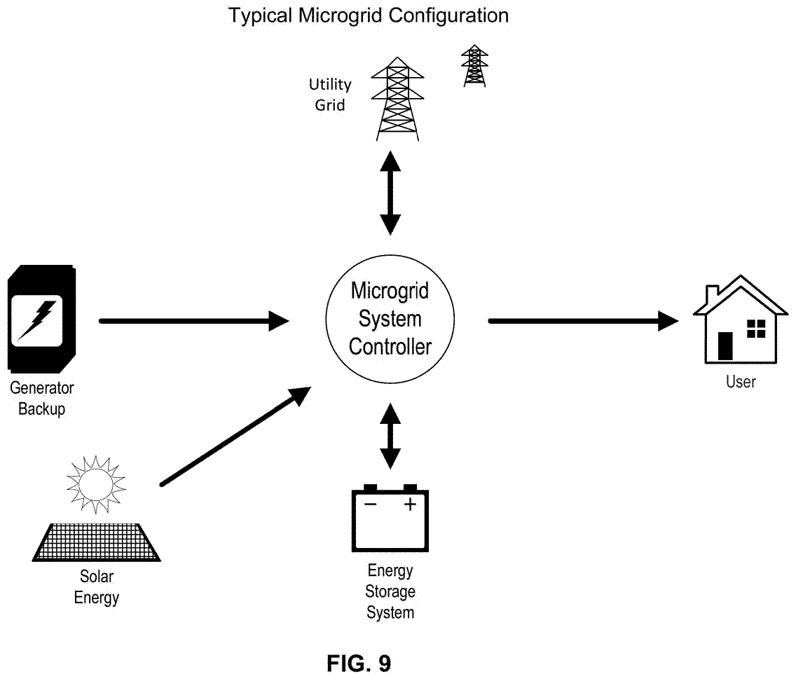

FIG. 9 illustrates an example microgrid configuration. The systems and methods described herein may be incorporated as the solar energy array of a microgrid system. Microgrid systems may deliver energy at all times of the day, seven days a week and fifty-two weeks a year, whether the sun is shining or not. For example, in addition to a solar energy array, microgrids may have one or more of 1) battery storage or other means to store electricity, 2) a generator and 3) a control system that manages the interchanges between the microgrid components and also manages the interaction with the energy user and potentially with a utility grid. A schematic diagram of a microgrid system is provided in FIG. 9. Further, the solar equipment in the systems and methods described herein may cover portions of the microgrid system so that land need not be solely dedicated to the equipment of the microgrid system, but may instead also be used to collect solar energy by solar panels covering that land.

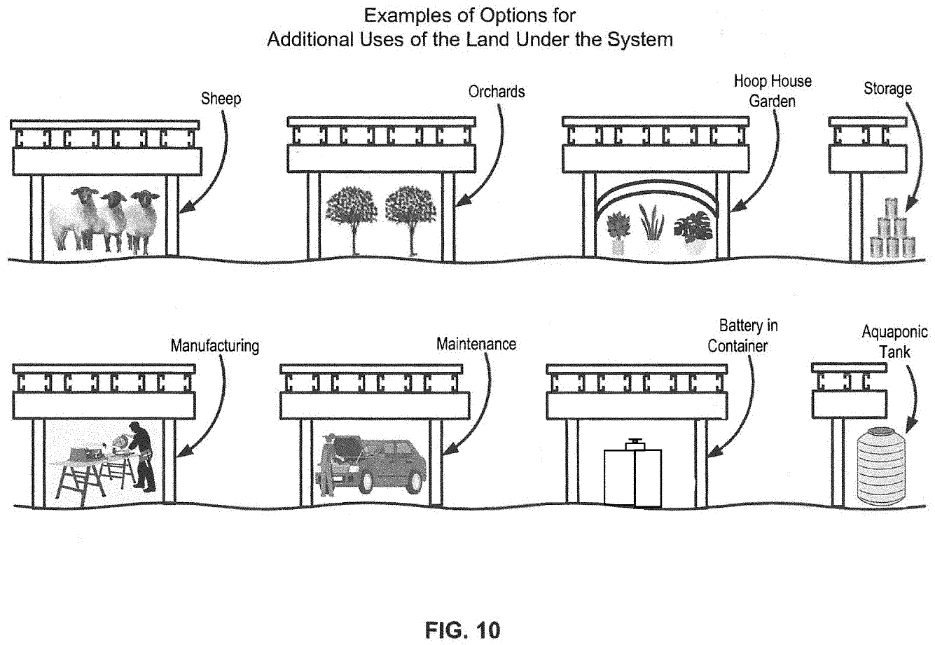

FIG. 10 illustrates examples of options for additional uses of the systems and methods described herein. The area under elevated solar energy structures may be used for many things that may not be possible under typical ground mounted solar energy structures. For example, the area under elevated solar energy structures may be used to grow plants, to graze animals, to store materials, to perform maintenance, or to do manufacturing or construction tasks. The area under elevated solar energy structures may be used to host public gatherings. Buildings might be built under the structures. Greenhouses might use the columns of the structure as some of the major supports for the glass walls and glass ceilings and make use of the solar panels to protect the glass from damage by hail storms. The structures may be built over canals to reduce water evaporation or may be used to provide aquaponics or other greenhouse environments. Elevating the entire solar energy collection system may enable the area where the system is located to be used in many ways in addition to the examples listed above, some of which are illustrated in FIG. 10.

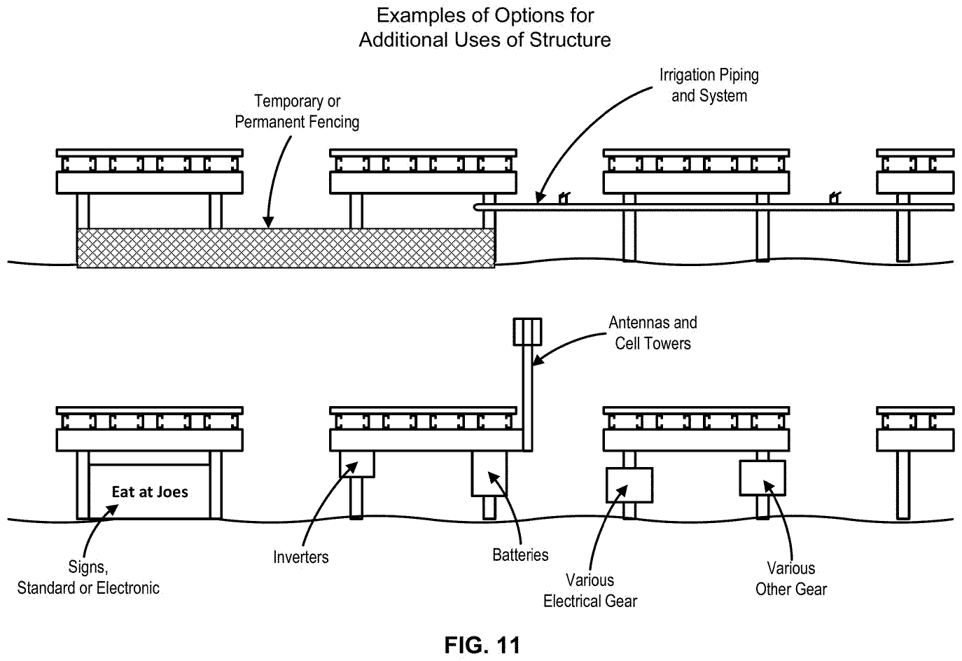

FIG. 11 illustrates examples of options for additional uses of the structures described herein. The structures included in the system may have additional uses beyond their principal use of supporting the solar energy collection system. For example, the structures may be used to support permanent or temporary fences to control livestock, keep out pests, for security or for other purposes. The structures may be used as supports for water piping for an irrigation system, for providing water to livestock, for pumping fluids to or from aquaponics tanks or for systems having solar panels used as part of the solar structure. In another example, the structures may be used as support for inverters, batteries or other energy storage systems, combined with other electronics associated with managing the solar panels or microgrid. In other embodiments, the structures may be used to support other electrical devices unrelated to energy management, such as cell phone transmitters, cell phone receivers, or cell phone transceivers, other transmitters, receivers, or transceivers, repeaters, lighting systems, signage control systems, security systems, or other electrical or electronic systems. The structures may be used to support lights for working under the system or lights to enhance plant growth or to support standard or electric signage. The structures may be used to support or be a portion of temporary or permanent shelters or agricultural enclosures. The structures may be used to support mechanical equipment of all types. Some embodiments may use the structures to support a combination of one or more of the examples listed. Some examples of potential additional uses of the structures that comprise the solar system are illustrated in FIG. 11, but others are also envisioned and included in other embodiments.

An embodiment may leave out one or more shade structure elements, such as solar panels. For example, solar panels may be purposely left out of the solar canopy or spaced closer together or further apart, be monofacial or bifacial and be of different degrees of transparent to opaque to allow different amounts of energy to be collected and different patterns of sunshine to reach the area covered, if so desired. In some embodiments, other arrangements of the solar panels in canopies of the system and other solar energy collection materials, such as shingles, cloth and paint among others, mounted on any appropriate surface are also contemplated.

Additional Statements:

In an example embodiment, the system covers an area of land or water and wherein at least one of the plurality of elevated rectilinear solar energy structures has a height that is at least 4 feet above the area covered. In an example embodiment, when the solar energy system is installed, the area covered by the solar energy system is capable of being used for at least one other purpose in addition to collecting solar energy. In an example embodiment, at a given height of the structures, a ratio of a width of solar canopies compared to a separation distance from the long side of at least one of the plurality of elevated rectilinear solar energy structures to the long side of an adjacent solar energy structure determines an amount of sunshine available for conversion into solar energy and the amount of sunshine available to reach the area covered by the solar energy system. In an example embodiment, at least one solar canopy structure of the plurality of elevated rectilinear solar energy structures is horizontal, wherein at least one of the plurality of solar panels comprising the solar energy collection canopy is mounted as a group and the plurality of solar panels are tilted between 0° and 15° relative to the at least one solar canopy structure. In an example embodiment, at least one solar canopy structure of the plurality of elevated rectilinear solar energy structures is tilted relative to horizontal. In an example embodiment, at least one of the plurality of solar panels comprising the solar energy collection canopy is mounted as a group and the plurality of solar panels are tilted between 0° and 15° relative to the at least one solar canopy structure.

In an example embodiment, at least one solar canopy structure of the plurality of elevated rectilinear solar energy structures is tilted to follow an angle of a surface of the area which the solar canopy structures covers in order to maintain a relatively uniform height of the solar energy collection canopy over the area, wherein at least one of the plurality of solar panels comprising the solar energy collection canopy is individually mounted and tilted between 0° and 30° relative to the at least one solar canopy structure. In an example embodiment, for at least one portion of a length of at least one of the solar energy structures of the plurality of elevated rectilinear solar energy structures, a height of the solar energy collection canopy, a width of the solar energy collection canopy and a separation between long sides of adjacent solar energy structures, a portion of the length of at least one of the plurality of elevated rectilinear solar energy structures, the height of the solar energy collection canopy, the width of the solar energy collection canopy and the separation between the long sides of adjacent solar energy structures, are consistent for at least one solar energy structure and a solar energy structure's neighboring solar energy structure.

In an example embodiment, one or more of the plurality of elevated rectilinear solar energy structures includes a canopy element that is not a solar panel for at least part of a length of at least one of the plurality of elevated rectilinear solar energy structures. In an example embodiment, some portions of the plurality of solar panels are purposely left out thereby reducing the amount of shade provided by the solar panels. In an example embodiment, the area covered by the solar energy system is used for a purpose in addition to collecting solar energy. In an example embodiment, some portions of the solar energy collectors are purposely left out thereby reducing the amount of shade provided by the solar energy collectors.

In an example embodiment, a method of collecting solar energy comprises the steps of: installing a first solar energy structure covering an area, the first solar energy structure being long, narrow and elevated; installing one or more additional solar energy structures, the one or more additional solar energy structures being long, narrow and elevated, and parallel to the first solar energy structure, the first solar energy structure and the one or more additional solar energy structures forming a solar energy system; wherein at least one portion of some of the long, narrow and elevated solar energy structures support a canopy of solar energy collectors; wherein at least one of the solar energy collectors supported by the canopy of solar energy collectors are tilted between 0° and 15° relative to the canopy of solar energy collectors; wherein the canopy of solar energy collectors is elevated to a minimum of 4 feet above the area covered; determining a desired amount of sunlight to reach the area covered by the solar energy system in order for the area to be used for purposes in addition to collecting solar energy; and adjusting a ratio of a width of the canopy of solar energy collectors to a separation distance from one long side of at least one of the first solar energy structure and the one or more additional solar energy structures to the long side of an adjacent solar energy structure to achieve the desired amount of sunlight reaching the area covered by the solar energy system. In an example embodiment, one or more of a plurality of solar canopies include a shading element that is not a solar panel. In an example embodiment, at least one of electrical equipment supporting an operation of the solar energy system is located under the solar energy system. In an example embodiment, the area under the solar energy system is used for agricultural purposes. In an example embodiment, some portions of the solar energy collectors are purposely left out thereby reducing the amount of shade provided by the solar energy collectors.

In an example embodiment, one or more of a plurality of solar canopies include a shading element that is not a solar panel. In an example embodiment, some portions of the solar energy panels are purposely left out thereby reducing the amount of shade provided by the solar energy panels.

While the principles of this disclosure have been shown in various embodiments, many modifications of structure, arrangements, proportions, the elements, materials and components used in practice, which are particularly adapted for a specific environment and operating requirements, may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes may be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A solar energy system comprising:
a plurality of elevated rectilinear solar energy structures covering an area, wherein each of the solar energy structures of the plurality of elevated rectilinear solar energy structures has a long side and a short side, the plurality of elevated rectilinear solar energy structures grouped together, oriented and aligned such that the long side of each of the solar energy structures are generally parallel; and
at least one of the plurality of elevated rectilinear solar energy structures has a plurality of solar panels attached in a fixed manner forming a solar energy collection canopy.

2. The solar energy system of claim 1, wherein a height of at least one of the plurality of elevated rectilinear solar energy structures is sufficiently high above the area to allow service vehicles to travel under the solar energy collection canopy, and wherein the plurality of solar panels making up a solar canopy are serviceable from underneath the solar canopy.

3. The solar energy system of claim 1, wherein a solar canopy is of sufficient height above the area to allow the area below to be used for something other than collection of solar energy.

4. The solar energy system of claim 1, wherein a separation between the long side of at least one of the plurality of elevated rectilinear solar energy structures and a long side of at least one adjacent solar collection structure is minimized in order to maximize an amount of sunshine available to be converted into solar energy.

5. The solar energy system of claim 1, wherein at least one solar canopy structure of the plurality of elevated rectilinear solar energy structures is horizontal, wherein at least one of the plurality of solar panels comprising the solar energy collection canopy is individually mounted and tilted between 0° and 15° relative to the at least one solar canopy structure.

6. The solar energy system of claim 1, wherein at least one solar canopy structure of the plurality of elevated rectilinear solar energy structures is tilted to follow an angle of a surface of the area which the solar canopy structures cover in order to maintain a relatively uniform height of the solar energy collection canopy over the area.

7. The solar energy system of claim 6, wherein at least one of the plurality of solar panels comprising the solar energy collection canopy is mounted as a group and the plurality of solar panels are tilted between 0° and 30° relative to the horizontal.

8. The solar energy system of claim 1, wherein the plurality of elevated rectilinear solar energy structures holding up the solar energy system has an additional purpose, including at least one of supporting pipes for transporting water, supporting grow lights, supporting lighting for working after dark or for security, supporting fixed or movable fencing, supporting signs, supporting portions of a shelter, supporting a greenhouse, supporting non-solar renewable energy generators, or supporting electrical equipment.

9. A method of collecting solar energy by:
installing a first solar energy structure covering an area, the first solar energy structure being long, narrow and elevated;
installing one or more additional solar energy structures, the one or more additional solar energy structures being long, narrow and elevated, and parallel to the first solar energy structure, the first solar energy structure and the one or more additional solar energy structures forming a solar energy system;
wherein at least one portion of at least one of the long, narrow and elevated solar energy structures support a canopy of solar energy collectors;
wherein at least one of the solar energy collectors supported by the canopy of solar energy collectors are tilted between 0° and 15° relative to horizontal; and
wherein the canopy of solar energy collectors is elevated to a minimum of 4 feet above the area covered.

10. The method of claim 9, wherein at least one of electrical equipment supporting an operation of the solar energy system is located under the solar energy system.

11. The method of claim 9, wherein long sides of the first solar energy structure and the one or more additional solar energy structures are oriented by 30° or less either way from a directly north to south orientation.

12. The method of claim 9, wherein the area covered by the solar energy system is used for a purpose in addition to collecting solar energy.

13. A microgrid energy system comprising:
at least one of an energy storage system, a generator, a control system and a solar energy collection system, wherein the solar energy collection system of the microgrid energy system comprises a group of elevated structures covering an area, each structure supporting one or more solar energy panels forming a canopy on the group of elevated structures, the longer side of at least one of a canopy of solar energy collectors being oriented parallel to the longer side of the canopy of solar energy collectors supported by neighboring solar energy structures.

14. The microgrid energy system of claim 13, wherein at least one of solar energy support equipment, the energy storage system, the generator and the control system are located under a solar canopy.

15. The microgrid energy system of claim 13, wherein the area covered by the microgrid energy system is used for a purpose in addition to collecting solar energy, wherein the area under the solar energy collection system is used for agricultural purposes.

16. A solar energy system comprising:
a plurality of elevated rectilinear solar energy structures covering an area, wherein at least two of the solar energy structures of the plurality of elevated rectilinear solar energy structures each comprise a solar table, wherein each solar table comprises a first pair of columns supporting a first crossbeam, a second pair of columns supporting a second crossbeam, and a third pair of columns supporting a third crossbeam, wherein each column is secured to the ground with a screw type securement, and each solar table further comprising pairs of purlins supported by the first, second, and third crossbeams, and each solar table further comprising solar panels, with each solar panel supported by at least one pair of purlins in a fixed manner forming a solar energy collection canopy, wherein each solar table comprises a long side and a short side, the plurality of elevated rectilinear solar energy structures grouped together, oriented and aligned such that the long side of each of the solar energy structures are generally parallel.

17. The solar energy system of claim 16, wherein a height of at least one of the plurality of elevated rectilinear solar energy structures is sufficiently high above the area to allow service vehicles to travel under the solar energy collection canopy.

18. The solar energy system of claim 16, wherein a solar canopy is of sufficient height above the area to allow the area below to be used for something other than collection of solar energy.

19. The solar energy system of claim 16, wherein the solar table is a first solar table comprising only two columns and only two crossbeams and the separation between the columns is sufficient for two cars to park between them plus a walking area for employees serving those cars.

20. The solar energy system of claim 19, wherein a second solar table comprises only one column and only one crossbeam and is connectable to the first solar table by connecting at least one purlin of one structure at least one purlin of the other structure.
